(19) United States
(12) Patent Application Publication
(10) Pub. No.: US 2025/0166630 A1
(43) Pub. Date: May 22, 2025

(54) TRANSLATION DEVICE

(71) Applicant: DAVINCIA, LLC DBA LINK ELECTRONICS, Branson, MO (US)

(72) Inventors: David Kendall, Branson, MO (US); Nicholas Cary, Oak Grove, AR (US)

(21) Appl. No.: 18/955,464

(22) Filed: Nov. 21, 2024

Related U.S. Application Data
(60) Provisional application No. 63/602,061, filed on Nov. 22, 2023.

(51) Int. Cl. G10L 15/26; G10L 15/00

(52) U.S. Cl. CPC G10L 15/26; G10L 15/005

(57) ABSTRACT

A translation device provides real-time speech-to-text conversion between different languages while maintaining original audio. The device includes an input port for receiving audio in a first language, an output port for displaying text in a second language, and a processing unit for translation. The processing unit incorporates an automatic speech recognition engine and large language model to enable accurate real-time translation. The technology is implemented in two primary configurations: a plug-and-play unit for multimedia applications and a portable handheld unit for field deployment. The plug-and-play version connects to entertainment systems through HDMI interfaces and allows users to control translation settings via smartphone or remote. The portable version includes a built-in display, microphone, and battery power for field operations.

### CROSS REFERENCE TO RELATED APPLICATIONS

This application claims the benefit of U.S. Provisional Application No. 63/602,061, filed on Nov. 22, 2023. The entire disclosure of the above application is incorporated herein by reference.

### FIELD

The present technology relates to translation devices and systems for converting audio input in a first language to text output in a second language, and, more particularly, to portable translation devices configured for both plug-and-play multimedia connections and handheld field applications.

### INTRODUCTION

This section provides background information related to the present disclosure which is not necessarily prior art.

Translation devices provide a way to overcome language barriers and facilitate effective communication in a globalized world. Translation devices can include mechanical translation devices, such as phrasebooks and dictionaries, as a means to bridge language gaps. However, such mechanical devices can be limited in effectiveness and require manual input and interpretation from the user. Development of electronic translation devices can be attributed to advancements in artificial intelligence, natural language processing, and machine learning.

Digital technology allows electronic translation devices to achieve remarkable accuracy and fluency in translating spoken and written language in real-time. Electronic translation devices can utilize algorithms and neural networks to analyze and understand context, grammar, and nuances of different languages, allowing for precise and contextually appropriate translations. Additionally, integration of cloud-based services and internet connectivity can expand the capabilities of translation devices by providing access to vast databases and language resources.

Electronic translation devices come in various forms, including handheld software applications and smart devices. They offer a range of features, such as voice recognition, speech synthesis, text-to-speech conversion, and multi-language support. Many electronic translation devices also incorporate additional functionalities, such as image recognition and augmented reality, to further enhance user experiences and enable seamless communication across cultural and linguistic boundaries. However, certain electronic translation devices are limited to translating between speech of a first language to speech of a second language or text of a first language to text of a second language. Additionally, certain translation devices do not have plug-and-play capabilities, are not convenient for use in the field such as in a military deployment, and/or can require an additional device such as a smart phone or other operating system.

Accordingly, there is a continuing need for a translation device capable of speech-to-text conversion between different languages. Desirably, the translation device can be used in a plug-and-play setting, or may be adapted for use in the field as a handheld mobile device.

### SUMMARY

In concordance with the instant disclosure, a translation device capable of speech-to-text conversion between different languages, and which can be used in a plug-and-play setting, or may be adapted for use in the field as a handheld mobile device, has surprisingly been discovered. The present technology includes articles of manufacture, systems, and processes that relate to translation devices capable of speech-to-text conversion between different languages, including plug-and-play devices for connecting to multimedia equipment and portable handheld devices for field applications.

In certain embodiments, the present technology provides a translation device. The translation device can include an input port, an output port, and a processing unit. The input port can be configured to receive an audio input of a first language. The output port can be configured to output a text output of a second language. The processing unit can be configured to translate the audio input of the first language to the text output of the second language. The input port and the output port can be in communication with the processing unit.

In certain embodiments, the present technology provides a translation device. The translation device can include an input port, an output port, and a processing unit. The input port can be configured to receive an audio input of a first language. The output port can be configured to output a text output of the first language. The processing unit can be configured to transcribe the audio input of the first language to the text output of the first language. The input port and the output port can be in communication with the processing unit.

In certain embodiments, the present disclosure provides a method for translating audio in a first language to text of a second language using a translation device. A translation device as described herein, an input device, and an output device can be provided. The input port of the translation device can be connected to the input device. The output port of the translation device can be connected to the output device. The user can use an integrated menu or, in certain embodiments, a smart phone application, to select the second language as well as the location and sizing of the text of the second language on the output device. The translation device can translate the audio input of the first language into the text output of the second language.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram depicting a translation device, according to a first embodiment of the present disclosure; and

FIG. 2 is a flow chart depicting a method for translating audio of a first language to text of a second language using the translation device of FIG. 1.

FIG. 3 is a block diagram depicting a translation device, according to a second embodiment of the present disclosure;

FIG. 4 is a flow chart depicting a method for translating audio of a first language to text of a second language using the translation device of FIG. 3;

FIG. 5 is a block diagram depicting a translation device, according to a third embodiment of the present disclosure; and

FIG. 6 is a flow chart depicting a method for translating audio of a first language to text of the first language using the translation device of FIG. 5.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves upon existing translation devices by providing a portable translation device capable of real-time speech-to-text conversion between different languages while maintaining the original audio, particularly in both plug-and-play multimedia applications and field deployment scenarios. The technology advances the field of translation devices by enabling direct audio-to-text translation functionality without requiring additional devices or operating systems, while offering versatile connectivity options through high-definition multimedia interface (HDMI) and other multimedia interfaces for seamless integration with existing audio-visual equipment. Additionally, the technology enhances field operations and military deployments by providing a standalone handheld device that can perform real-time translations without relying on external systems or cloud connectivity, addressing limitations of current translation solutions that are restricted to either speech-to-speech or text-to-text translations.

It should be appreciated that the translation device can be configured to operate completely offline as a standalone unit without connection to the cloud or the internet, providing security and independence from external services and militating against outside influence and instability. In this way, the translation device does not require cell signal or cloud connectivity and performs all processing internally within the unit itself. The offline capability allows the translation device to be useful in applications requiring heightened security measures, such as military deployments, local law enforcement operations, and medical settings where HIPAA compliance requires that sensitive information cannot be transmitted to external cloud services. The translation device achieves the standalone functionality through an integrated processing unit containing both an automatic speech recognition engine and a large language model that operate entirely within the device. Although the translation device can operate offline, the translation device can also be configured for online use, as described herein. A skilled artisan can select a suitable configuration within the scope of the present disclosure.

In certain embodiments, the present technology can provide a translation device configured to receive an input in a first language and generate an output in a second language. For example, the translation device can be configured to receive an audio input in the first language and generate a text output in the second language. In another example, the translation device can be configured to receive the audio input in the first language and generate a text output in the first language. In another example, the translation device can be configured to receive the audio input in the first language and generate an audio output in the second language. The translation device can be implemented in two primary configurations: a plug-and-play translation device for multimedia applications and a handheld translation device for field deployment, which are described in greater detail herein. In general, the translation device can include an input port, an output port, and a processing unit.

The input port can be configured to receive the audio input of the first language through various means and configurations. For the plug-and-play implementation, the input port can include HDMI connections that can receive audio input from multimedia boxes, cable boxes, and gaming systems. Other non-limiting examples of the input port can include SDI, a 3.5 mm jack, USB, HDMI, microphone input, line input, XLR, RCA, and optical audio. A skilled artisan can select a suitable input port within the scope of the present disclosure.

The HDMI implementation can utilize HDMI Driver IC components to manage the audio signal processing. For the field/portable implementation, the input port can be configured to receive audio through built-in or external microphones for direct speech capture. The microphone inputs can be configured to receive and convert speech into input speech data as a digital speech signal.

Both the plug-and-play unit for multimedia applications and the portable handheld unit for field deployment can include wireless connectivity options, where the input port can receive audio through wireless connections such as Bluetooth, Wi-Fi, or other wireless protocols. The wireless module can enable communication with external audio input devices and can support various wireless communication standards including Bluetooth, infrared, IEEE 802-11x, and other short-range communication protocols. The input port can also include any audio date from any capable device, including, for example, USB ports, VGA ports, a microphone, a speaker, and DVI ports to accommodate different types of audio input sources and connection requirements. These various input configurations can enable the translation device to receive audio input from a wide range of sources while maintaining compatibility with different audio input devices and systems. Advantageously, the translation device can be configured to process the received audio input in real-time, regardless of the input method used, to perform the translation from the first language to text in the second language. The input port can be designed to support plug-and-play functionality, allowing for seamless connection to various multimedia devices while maintaining high-quality audio signal transmission.

The output port can be configured to output the text of the second language to various display devices through multiple configurations. For the plug-and-play implementation, the output port can include HDMI output connections that can display translated text on external devices such as televisions and monitors. The HDMI implementation can utilize HDMI ReDriver IC components to manage the video signal processing and text display. A ReDriver IC, also known as repeater IC, can regenerate signals to boost signal quality of a high-speed interface. The ReDriver can use equalization, pre-emphasis, and other technologies that can adjust and correct for known channel losses at a transmitter and restore signal integrity at a receiver. For the field/portable implementation, the output port can be configured to output translated text to a built-in display screen. The display can include a liquid crystal display, an OLED display, or other suitable display technologies. The display can be configured to show texts and images based on user operations.

The output port can be configured to display the translated text in various formats and positions on the screen. The user can control the location and sizing of the text of the second language on the screen through an integrated menu or, in certain embodiments, through a smartphone application. The screen can be configured to maintain the original layout and presentation quality while displaying the translated text. The text output can be adjusted for font, font size, character spacing, and line spacing to ensure optimal visibility and readability on the connected display device.

Advantageously, translation can occur in real-time, allowing users to simultaneously hear the original audio in the first language while reading the translated text in the second language. The output capabilities can include various port options such as HDMI, VGA, DVI, and USB to accommodate different types of display devices and connection requirements. These various output configurations can enable the screen to display translated text on a wide range of display devices while maintaining compatibility with different display systems and resolutions.

The translation device can maintain the original audio while simultaneously displaying the translated text, allowing users to experience both languages concurrently. This functionality can be particularly useful during travel to countries that speak a foreign language or during multi-language meetings, as users can hear the first language while reading the second language in real-time on the output device. The translation can be displayed as subtitles or text overlay while preserving the original audio content.

The processing unit can be configured to translate between the audio input of the first language and the text output of the second language using sophisticated translation capabilities. The text output can include text output data, which can be exported for other use or used for closed captioning purposes. The processing unit can include a CPU/NPU (Central Processing Unit/Neural Processing Unit) that can be configured to execute translation operations and run artificial intelligence models for language processing. The CPU/NPU can be configured to process input data according to predefined operation rules or artificial intelligence models stored in memory. The processing unit can also include an embedded operating system. For example, the operating system can include a Linux operating system. The embedded operating system can manage the core functions and operations of the translation device. The operating system can control the processing of input data according to predefined operation rules and manage the artificial intelligence models. The operating system can coordinate between the hardware components and provide the framework for the translation functionalities. The processing unit can be implemented through various types of processors such as a CPU, MPU, GPU, DSP, FPGA, or ASIC, and can be configured to perform multiple processes simultaneously to enable real-time translation capabilities.

The translation device can include random access memory (RAM) which can be used for active processing operations and temporary data storage. The RAM can store various types of media, guidance application data, program information, settings, and user preferences. Non-volatile memory can also be used for boot-up routines and other instructions.

Flash storage can be provided as part of a storage system of the translation device. The flash storage can be used to store computer programs, data necessary to perform various functions, and translation-related information. The storage can include non-transitory computer-readable storage media such as flash memory, solid state drive (SSD), optical disc and/or hard disk.

The translation device can also include a wireless module. The wireless module can enable communication capabilities through various protocols. The wireless communication can include wireless LAN (Wi-Fi), Bluetooth, Bluetooth low energy, Zigbee, Wi-Fi direct (WFD), ultra wideband (UWB), infrared data association (IrDA), and near field communication (NFC). This allows for connectivity with external devices and networks.

The processing unit can include the automatic speech recognition (ASR) engine configured to facilitate computer speech recognition and speech-to-text conversion. The ASR engine can enable the processing of human speech into written format by analyzing and converting the audio input patterns into text through pattern recognition algorithms. The ASR engine can employ advanced acoustic modeling and language modeling techniques to accurately transcribe spoken words, accounting for variations in pronunciation, accent, and speech patterns. As such, the ASR engine can be configured to translate the audio input of the first language into the text output of the second language through a multi-step process of speech recognition, language processing, and text generation.

The processing unit can also include the large language model (LLM) that works in conjunction with the ASR engine to enhance translation accuracy and natural language understanding. The LLM can be configured to perform multiple functions including recognition of linguistic patterns, summarization of key content, translation between language pairs, prediction of appropriate linguistic constructs, and generation of natural-sounding text output in the target language. The LLM can employ deep learning architectures to understand context, maintain semantic consistency, and preserve the nuanced meaning of the original speech during translation. The LLM can be configured to handle complex linguistic phenomena such as idiomatic expressions, cultural references, and context-dependent meanings. The model can continuously process and analyze the input to generate appropriate translations while maintaining grammatical accuracy and natural language flow in the target language.

The LLM can be implemented using state-of-the-art language models such as GPT-4, LLaMa, PaLM, BLOOM, Ernie 3.0 Titan, or Claude. Each of these models offers unique capabilities in natural language processing and can be optimized for specific translation tasks. The selection of the specific LLM can be based on factors such as language pair requirements, processing speed needs, and accuracy requirements for a particular application. The combination of the ASR engine and LLM enables the processing unit to perform real-time translation while maintaining high accuracy and natural language output. This integrated approach allows for efficient handling of various speech patterns, accents, and linguistic variations while producing accurate translations that preserve the original meaning and context of the spoken input.

The handheld translation device can include a housing configured to enclose and protect the internal components while maintaining portability for field use. The housing can be sized and shaped to be easily carried and transported in a bag or suitcase. The housing can include a built-in display screen with a touchscreen panel superimposed on the display. The touchscreen panel can be configured to accept direct touch operations from the user. The housing can include integrated audio components including a built-in microphone configured to receive and convert speech into digital speech signals, and built-in speakers or audio output ports configured to output translated audio. The device can include ports for connecting external speakers, earpieces, or headphones for audio output.

The housing can incorporate a battery power system configured to enable portable operation of the device. The battery system can be designed to power all core components including the CPU/NPU, display screen, wireless modules, and other electronic components. The battery power system can enable operation in field conditions where external power sources may not be readily available. The housing can include various external ports and interfaces configured for device operation and connectivity. The external ports can include audio output connections, a removable memory device slot configured to allow storage and export of recorded transcripts, a charging port for the battery system, and ports for optional external microphone connections. The housing can also incorporate wireless communication components configured to enable Bluetooth and Wi-Fi connectivity.

In the handheld device embodiment, for example, a military service member can use the translation device during field operations to communicate with local populations. The service member can speak into the built-in microphone of the device, and the translated text can appear on the built-in display while maintaining the original audio. The device can store the conversation transcript on the removable memory device for later reference and documentation. In another example, a business traveler can use the handheld device during international meetings by speaking into the microphone and having the translation displayed on the screen. The traveler can use headphones to hear the translated audio while maintaining a record of the conversation through the transcript feature.

The plug and play translation device can include a housing configured for permanent installation and rack mounting in fixed locations. The housing can be configured to be more robust compared to the portable version, allowing for sustained use in commercial settings such as hotel rooms where multiple guests can access the translation capabilities during their stays.

The plug and play translation device can be configured to connect to hotel entertainment systems, allowing guests to access translation services through a television or multimedia system in a hotel room of the user. The translation device can include wireless connectivity to enable guests to control translation settings through a programmable device. The programmable device can be configured as a wireless device that communicates with the translation device through Bluetooth or other wireless protocols. The device can include a processor and non-transitory computer readable medium containing instructions that allow users to select their desired translation language and control how the translated text appears on the output display. When implemented as a smartphone application, the programmable device can provide users with an interface to control translation settings and preferences. The application can allow users to select the output language, adjust the positioning and size of translated text on the display, and manage other device settings. For commercial installations like hotels, the smartphone app can also enable guest access to translation services and facilitate usage tracking.

Alternatively, the programmable device can be implemented as a dedicated remote control with a touch-sensitive screen or keypad. Such a remote can include a liquid crystal display (LCD), manual buttons or keys, and wireless communication capabilities. The touch-sensitive screen can be configured to display only the controls relevant to the specific task being performed, with the interface changing based on the active application. The remote can also include a combination of push buttons.

Using the plug and play translation device, hotel guests can watch television programming in their native language by having the original audio play while reading the translated subtitles on their room's television screen. The guest can use their smartphone to select their preferred language and adjust the positioning of the subtitles through the hotel's translation system. In a further example, a conference center can install the rack-mounted version to provide real-time translation services during international meetings. Attendees can hear the original speaker while reading translations on display screens throughout the venue, with each participant able to select their preferred language through their smartphone.

The present disclosure further provides a method for translating audio of a first language to text of a second language using a translation device. First, a translation device can be provided that includes an input port configured to receive an audio input of a first language, an output port configured to output a text output of a second language, and a processing unit configured to translate between the languages. The method can include receiving an audio input through the input port, where the audio input contains speech in the first language. The processing unit can then process this input using an automatic speech recognition (ASR) engine to facilitate computer speech recognition and convert human speech into a written format. The processing unit, can recognize, summarize, translate, predict, and generate the text output of the second language from the audio input of the first language. The translation device can then output the translated text through the output port. The translation of the audio input of the first language to the text output of the second language can occur in real-time, allowing for immediate communication between speakers of different languages. The method can include storing and exporting a copy of the recorded transcript on a removable memory device for later reference. The device can also include various supplementary features such as battery operation and wireless communication capabilities for inputs and outputs.

### EXAMPLES

Example embodiments of the present technology are provided with reference to the several figures enclosed herewith.

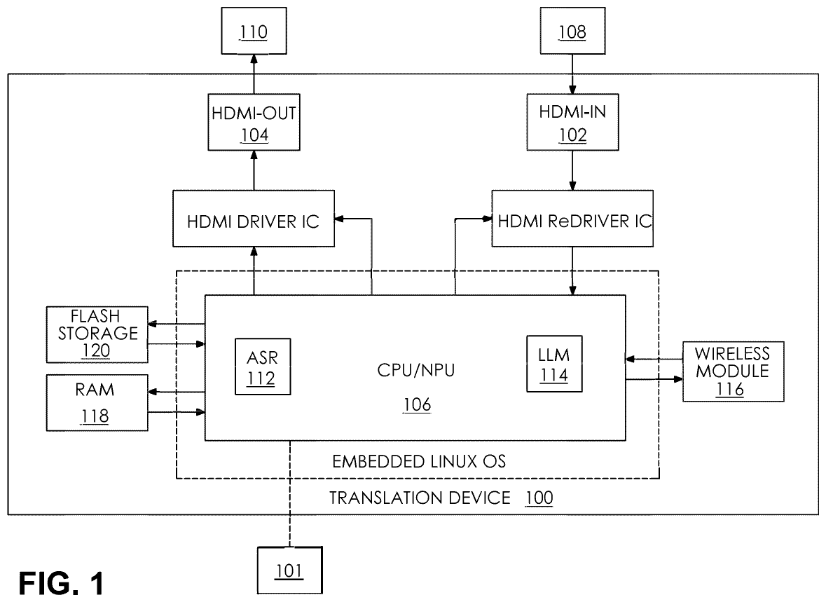

With reference to FIG. 1, a plug and play translation device 100 is shown. The translation device 100 can include an input port 102, an output port 104, and a processing unit 106. The input port 102 can be configured to receive an audio input of a first language 108. The output port 104 can be configured to output a text output of a second language 110. The processing unit 106 can be configured to translate the audio input of the first language 108 to the text output of the second language 110. The input port 102 and the output port 104 can be in communication with the processing unit 106. Advantageously, the translation device 100 can be utilized during travel to countries that speak a foreign language or during multi-language meetings. The input port 102 of the translation device 100 can be plugged into a multimedia box, a cable box, or a gaming system to translate the audio input of a first language 108 into the text output of a second language 110 to allow the user to hear the first language and read the second language in real-time on an output device, such as a television or monitor, connected to the output port.

As shown in FIG. 1, the processing unit 106 can include an automatic speech recognition (ASR) engine 112. The ASR engine 112 can be configured to facilitate computer speech recognition, or speech-to-text, and is able to enable a program to process human speech into a written format. As such, the ASR engine 112 can be configured to translate the audio input of the first language 108 into the text output of the second language 110. The processing unit 106 can also include a large language model (LLM) 114. The LLM 114 can be configured to recognize, summarize, translate, predict, and generate the text output of the second language from the audio input of the first language.

In certain embodiments, the translation device 100 further including a programmable device 101 configured for wireless communication with the processing unit 106. The programmable device 101 can include a processor and a non-transitory computer readable medium. The non-transitory computer readable medium can include instructions configured to permit the user to select the second language. As an example, the programmable device 101 can be connected to the translation device via Bluetooth™M. As shown in FIG. 1, the translation device 100 can include a wireless module 116, a memory 118, and a flash storage 120.

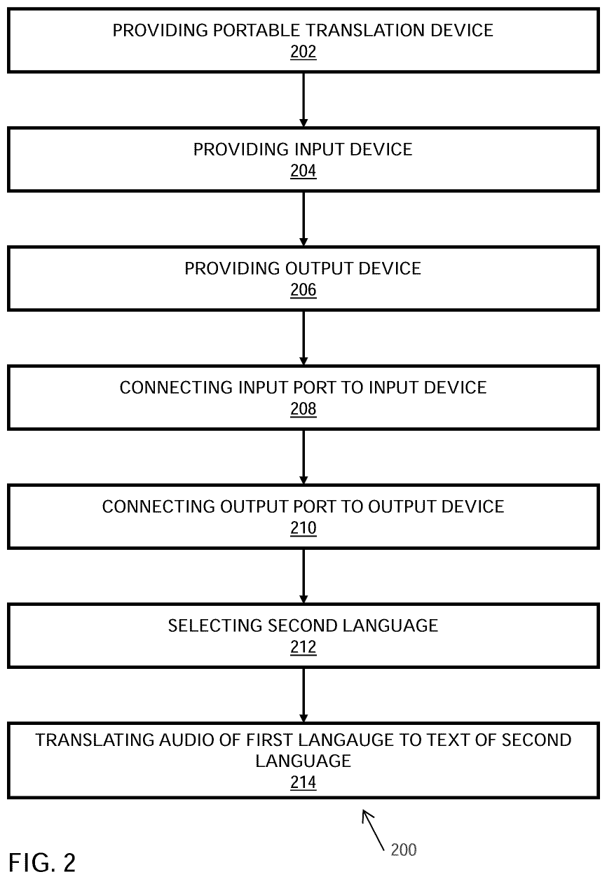

With reference to FIG. 2, the present disclosure further provides a method 200 for translating audio of a first language 108 to text of a second language 110 using a translation device, for example, as shown in FIG. 1. In a step 202, a translation device 100 as described hereinabove is employed. An input device, such as a multimedia box, cable box, and gaming system can be provided in a step 204. In a step 206, an output device, such as a television or monitor, can be provided. The input port 102 of the translation device 100 can be connected to the input device in a step 208. In a step 210, the output port 104 of the translation device 100 can be connected to the output device. The user can use an integrated menu or, in certain embodiments, a smart phone application, to select the second language 110 as well as the location and sizing of the text of the second language on the output device in a step 212. The translation device 100 can translate the audio input of the first language 108 into the text output of the second language 110 in a step 214.

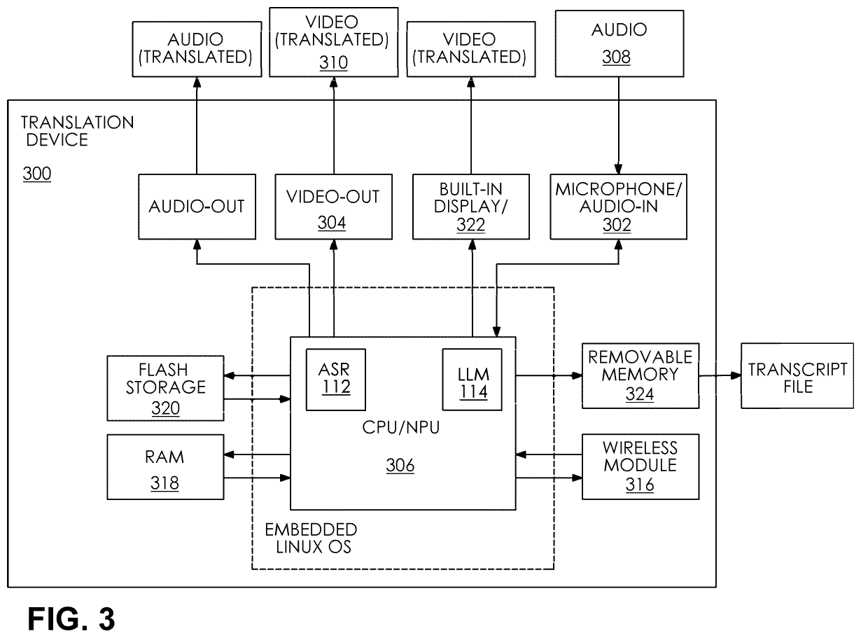

In a second embodiment shown generally in FIG. 3, a handheld translation device 300 may be especially adapted for field use such as in military deployments, as a non-limiting example. The various components described hereinabove with respect to the first embodiment of FIG. 1 may also be employed with the second embodiment of FIG. 3 and are shown in FIG. 3 in a 300-series reference numeral instead of a 100-series reference numeral for purpose of clarity.

As shown in FIG. 3, for example, the translation device 300 can take in audio 308 via an audio input 302 such as a microphone. The translation device 300 can be set to translate the input language to an output language. This output language is then able to be displayed on a built-in display 322 on the unit. In addition, the output language can be displayed via some video output. The translation device 300 may also be able to take the input audio and convert it into audio of the translated, destination language to be listened to. The output audio could be done via speaker (built-in or external), as well as an earpiece or headphones. The device is also able to store and export a copy of the recorded transcript on a removable memory device 324. The device could have a variety of other features including but not limited to battery operation, Bluetooth/wireless communications for the inputs and outputs, and modular design.

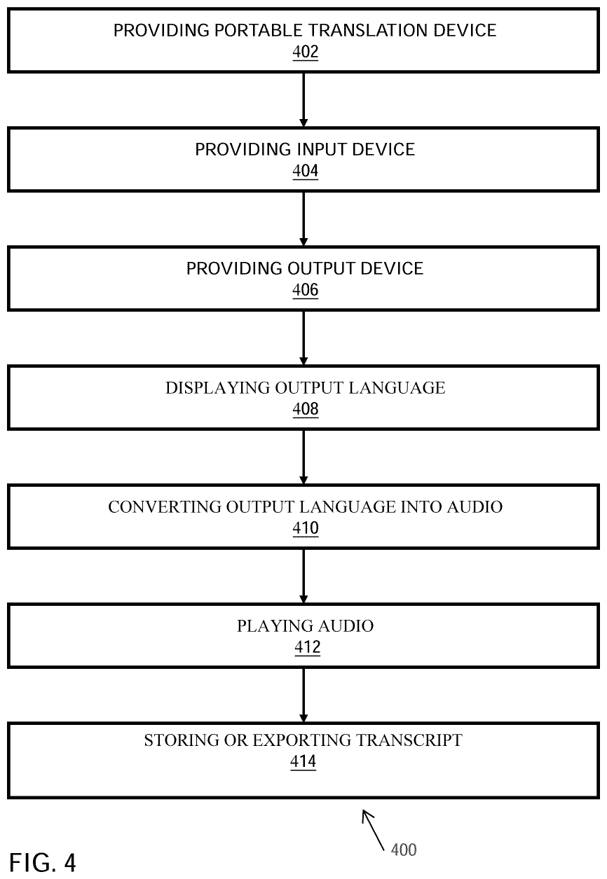

The present disclosure further provides a method 400 for translating audio of a first language 408 to text of a second language 410 using a translation device 300, for example, as shown in FIG. 3. The various steps described hereinabove with respect to the first embodiment of FIG. 2 may also be employed with the second embodiment of FIG. 4 and are shown in FIG. 4 in a 400-series instead of a 200-series for purpose of clarity. In a step 402, a translation device 300 as described hereinabove is employed. An input device, such as a microphone can be provided in a step 404. In a step 406, an output device, such as a built-in display, can be provided. The output language can be displayed on the built-in display for example in a step 408. In a step 410, the input audio may be converted into audio of the translated, designation language to be listened to, for example, by converting the output language displayed to audio. The user can use an integrated menu or, in certain embodiments, a software application, to select the output language as well as the location and sizing of the text of the output language on the output device in a step 412. The translation device 300 can also store and export a copy of the recorded transcript in a step 414, for later use.

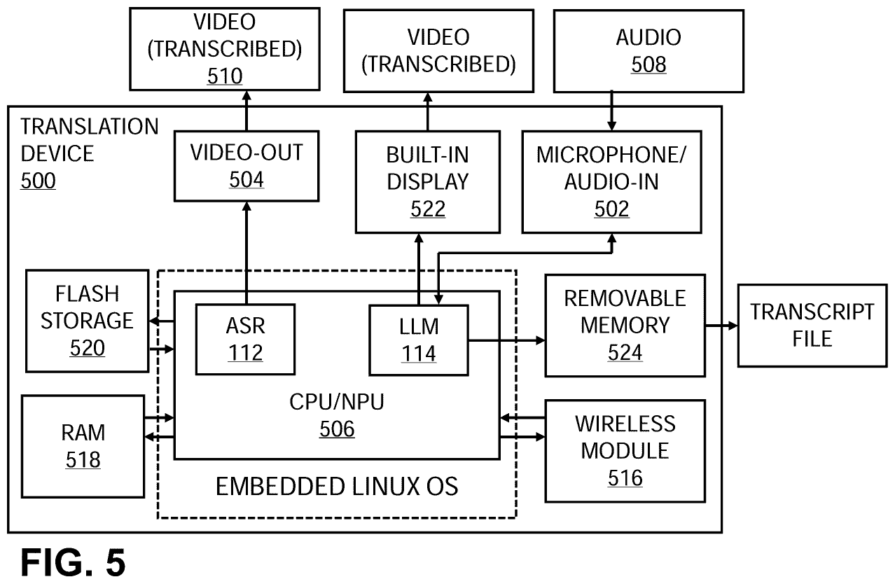

In a third embodiment shown generally in FIG. 5, a handheld translation device 500 may be especially adapted for offline field use such as in a medical setting or a law enforcement environment, as a non-limiting example. The various components described hereinabove with respect to the first embodiment of FIG. 1 may also be employed with the third embodiment of FIG. 5 and are shown in FIG. 5 in a 500-series reference numeral instead of a 100-series reference numeral for purpose of clarity.

As shown in FIG. 5, for example, the translation device 500 can take in an audio 508 via an audio input such as a microphone. The translation device 500 can be set to transcribe the audio input to a text output 510, which can be displayed via some video output 504. For purposes of this example, the audio input 508 and the text output 510 can both be in the same language. The output audio could be done via speaker (built-in or external), as well as an earpiece or headphones. The device is also able to store and export a copy of the recorded transcript on a removable memory device 524. The device could have a variety of other features including but not limited to battery operation, Bluetooth/wireless communications for the inputs and outputs, and modular design.

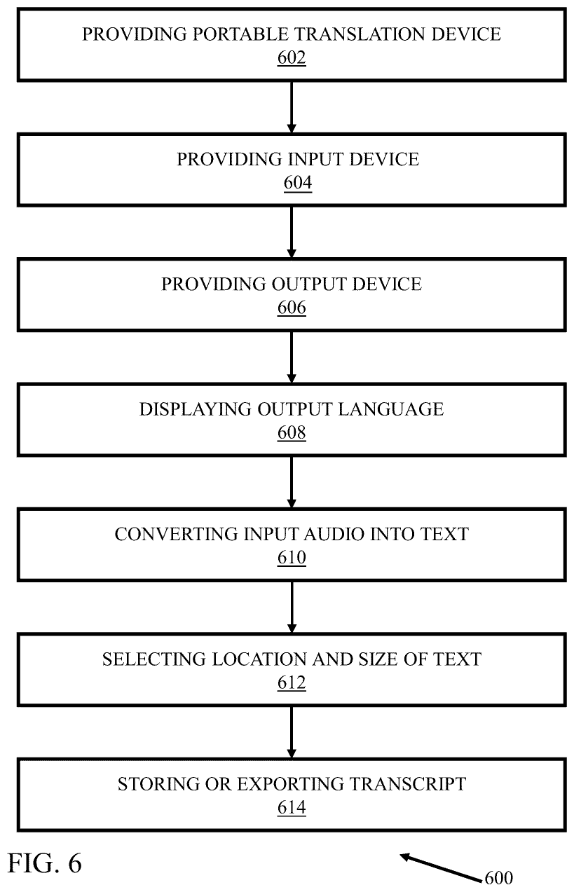

The present disclosure further provides a method 600 for transcribing audio of a first language 608 to text of the same language 608 using a translation device 500, for example, as shown in FIG. 5. The various steps described hereinabove with respect to the first embodiment of FIG. 2 may also be employed with the third embodiment of FIG. 6 and are shown in FIG. 6 in a 600-series instead of a 200-series for purpose of clarity. In a step 602, a translation device 500 as described hereinabove is employed. An input device, such as a microphone can be provided in a step 604. In a step 606, an output device, such as a built-in display, can be provided. The output language can be displayed on the built-in display for example in a step 608. In a step 610, the input audio may be converted, by transcription, into text of the same language. The user can use an integrated menu or, in certain embodiments, a software application, to select the location and sizing of the text of the output on the output device in a step 612. The translation device 500 can also store and export a copy of the recorded transcript in a step 614, for later use.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A translation device, comprising:
an input device configured to receive an audio input of a first language;
an output device configured to output a text output of a second language; and
a processing unit configured to translate the audio input of the first language to the text output of the second language, the processing unit in communication with the input device and the output device.

2. The translation device of claim 1, wherein the processing unit includes an automatic speech recognition (ASR) engine configured to receive the audio input in the first language, perform computer speech recognition, and convert the audio input into the text output in the second language.

3. The translation device of claim 1, wherein the processing unit includes a large language model (LLM) configured to recognize, summarize, translate, and predict the audio input of the first language and generate the text output of the second language.

4. The translation device of claim 3, wherein the LLM includes one of GPT-4, LLaMa, PaLM, BLOOM, Ernie 3.0 Titan, and Claude.

5. The translation device of claim 1, further including a wireless module configured to enable wireless communication through one of Bluetooth, Wi-Fi, infrared, and IEEE 802-11x.

6. The translation device of claim 1, further including a programmable device configured for wireless communication with the processing unit, wherein the programmable device includes a processor and non-transitory computer readable medium containing instructions configured to permit selection of the second language.

7. The translation device of claim 1, wherein the input device includes one of an HDMI connection, USB port, VGA port, and DVI port.

8. The translation device of claim 1, wherein the output device is configured to display the text output in various formats and positions on a screen.

9. The translation device of claim 1, further including a housing configured to enclose and protect internal components.

10. The translation device of claim 9, wherein the housing includes a built-in display screen with a touchscreen panel.

11. The translation device of claim 10, further including a battery power system configured to enable portable operation.

12. The translation device of claim 10, further including a removable memory device slot configured to allow storage and export of recorded transcripts.

13. The translation device of claim 1, further including a programmable device in wireless communication with the processing unit.

14. The translation device of claim 1, wherein:
the processing unit includes an automatic speech recognition (ASR) engine configured to facilitate computer speech recognition and convert human speech into the text output;
the processing unit includes a large language model (LLM) configured to recognize, summarize, translate, predict, and generate the text output, and the LLM includes one of GPT-4, LLaMa, PaLM, BLOOM, Ernie 3.0 Titan, and Claude; and
the translation device further includes a wireless module configured to enable wireless communication through one of Bluetooth, Wi-Fi, infrared, and IEEE 802-11x.

15. The translation device of claim 14, wherein:
the translation device includes a housing configured to enclose and protect internal components while maintaining portability for field use;
the housing includes a built-in display screen with a touchscreen panel;
the translation device includes a battery power system configured to enable portable operation; and
the translation device includes a removable memory device slot configured to allow storage and export of recorded transcripts.

16. A translation device, comprising:
an input device configured to receive an audio input of a first language;
an output device configured to output a text output of the first language; and
a processing unit configured to transcribe the audio input of the first language to the text output of the first language, the processing unit in communication with the input device and the output device.

17. A method for translating audio of a first language to text of a second language using a translation device, comprising:
providing a translation device having an input port configured to receive an audio input of a first language, an output port configured to output a text output of a second language, and
a processing unit configured to translate the audio input of the first language to the text output of the second language, the processing unit in communication with the input device and the output device;
providing an input device;
providing an output device;
connecting the input device of the translation device to the input port;
connecting the output device of the translation device to the output port;
translating the audio input of the first language into the text output of the second language.

18. The translation device of claim 17, wherein:
the processing unit includes an automatic speech recognition (ASR) engine configured to facilitate computer speech recognition and convert human speech into the text output;
the processing unit includes a large language model (LLM) configured to recognize, summarize, translate, predict, and generate the text output, and the LLM includes one of GPT-4, LLaMa, PaLM, BLOOM, Ernie 3.0 Titan, and Claude; and
the translation device further includes a wireless module configured to enable wireless communication through one of Bluetooth, Wi-Fi, infrared, and IEEE 802-11x.

19. The method of claim 17, wherein the input device includes one of a multimedia box, cable box, and gaming system.

20. The method of claim 17, wherein the output device includes one of a television and a monitor.
